(19) United States
(12) Patent Application Publication
(10) Pub. No.: US 2010/0147195 A1
(43) Pub. Date: Jun. 17, 2010

(54) WATER RESISTANT CONCRETE ADMIXTURES, FORMULATIONS AND MASONRY UNITS

(75) Inventors: Craig Thomas WALLOCH, Norcross, GA (US); Theodore George Light, Suwanee, GA (US); Marshall Lee Brown, Berkeley Lake, GA (US)

Correspondence Address: MILLEN, WHITE, ZELANO & BRANIGAN, P.C., 2200 CLARENDON BLVD., SUITE 1400, ARLINGTON, VA, 22201, US

(73) Assignee: ACM Chemistries, Inc., Norcross, GA (US)

(21) Appl. No.: 12/632,146

(22) Filed: Dec. 7, 2009

Related U.S. Application Data
(60) Provisional application No. 61/120,622, filed on Dec. 8, 2008.

(51) Int. Cl. C04B 24/08; C04B 16/00; C04B 24/00; C04B 24/26; C04B 24/28

(52) U.S. Cl. 106/660; 106/665; 106/806; 106/819; 106/822; 524/2; 524/5; 524/261

(57) ABSTRACT

Embodiments of the invention provide cement and concrete admixtures and mixes, and CMUs made therewith that provide improved water resistance. Embodiments provide methods for making the admixtures, the mixes and the CMUs.

### RELATED APPLICATION

This application claims priority under 35 U.S.C. §119(e) from U.S. Provisional Application No. 61/120,622, filed Dec. 8, 2008, the entirety of which is incorporated herein by reference.

### BACKGROUND

Concrete masonry units (“CMUs”) are preformed concrete products used ubiquitously in building construction, civil engineering and landscaping applications, among others. Examples include concrete blocks used for building foundations and walls, concrete pavers used for sidewalks and pavements, segmental units for segmental retaining walls, concrete pipes used for drainage control, and concrete tiles for roofing, walls and decorative applications, to name just a few.

CMUs typically are made using non-plastic cement or concrete mixes that have a relatively low water content per unit volume. Nonplastic cements and mixtures typically contain Portland cement, aggregates and water, and may also contain other ingredients such as fly ash, other pozzolanic materials, or coloring pigments. They differ significantly from plastic mixes which contain relatively more water, are therefore more workable and typically set and harden under ambient conditions. Nonplastic cements and mixes, in contrast to plastic mixes, generally have sufficient structural integrity to retain a shape without the aid of a mold or form, can be forced into molds and through extruders, can be cured outside the mold or form, under steam and at elevated temperature, and tend to have little or no “slump” after being molded, formed or shaped. The resulting products often are referred to as low or no slump concrete products.

Currently, nonplastic mixes are used nearly universally to produce CMUs, and they have served well in the production of a very wide variety of products. However the mixes and the CMUs made from them still have some drawbacks that the industry has not fully resolved. One as yet unsolved problem relates to water penetration resistance. It has long been a goal of concrete materials suppliers to provide CMUs with superior water resistance that meet the demands of a wide range of applications, without the need for customizing production materials, such as admixtures, or processes. To achieve this goal the industry has pursued two main approaches: external water repellent treatments and integral water repellent admixtures. While both approaches can improve water penetration resistance in some situations, neither provides a fully satisfactory solution.

In external water repellent approaches, a water repellent treatment or material is applied to the CMU after it has been fabricated. All such post-fabrication external water repellent treatments have notable disadvantages. In particular, they all require additional processes for applying the coating and, generally, for curing it. These add to the cost of fabrication, as well as the time, and introduce additional potential points of failure to the fabrication and quality control process. Furthermore, external coatings applied at the factory can fail during transport and installation, and those applied on-site further add to cost and time, and are prone to quality variation. Finally, external water repellent treatments often do not last as long as the CMUs themselves, unnecessarily limiting their application where water penetration resistance is essential over the CMU lifetime, or incurring the additional expenses of later, supplementary applications to renew coatings before they fail. Examples of external water repellent approaches in which the treatment is applied to the surface of the concrete are described in published European patent applications numbers EP-B-0538 555, EP-B-0340816, and EP-A-0234024.

Integral water repellent admixtures avoid many of the disadvantages of external water repellent treatments and have been pursued by several manufacturers. However, acceptable admixtures for integral water repellence must not adversely affect the properties of the concrete mixes and the resulting concrete. Thus, they must not degrade workability, alter set times undesirably, decrease strength, or unduly alter porosity, to name a few qualities. A few integral water repellent concrete admixtures and mixtures have been developed, such as those described by Gobel et al. in U.S. Pat. No. 6,139,622, in which silane-siloxane emulsions are used. These relate primarily to regular ready-mix concrete that generally is fluid and is referred to as ‘wet-cast’ rather than dry cast mixtures of the type used to make CMUs. As shown below, these also have performance disadvantages. In particular, some integral water repellent compositions provide good resistance to water penetration due to capillary suction, but are not effective in resisting water penetration through “pinholes” which are macro-pores in the concrete matrix that occur when the aggregate blend does not fit tightly together enough. To remedy pinholing with these compositions it has been necessary to carefully customize aggregate blends, which does not always work, generally is difficult to achieve, is expensive, and often has to be repeated from lot to lot to adjust for the natural variations in aggregate blends.

There are two commonly employed tests for water repellency of concrete, including CMUs. The water uptake test measures the amount of water taken up by the concrete due to capillary suction under particular conditions, as a fraction of the total saturation of the test specimen. To be an acceptable water-repellent material, National Concrete Masonry Association (NCMA), in its TEK 19-7, Characteristics of Concrete Masonry Units with Integral Water Repellent, recommends that the water uptake value be less than 60% of total saturation after 24 hours.

The spray bar test measures the ability of sprayed water to penetrate the concrete, and is particularly sensitive to pinholes. In NCMA TEK 19-7, the recommended minimum criteria for passing the spray-bar test is for there to be less than 20% dampness on the inside of the front face shell and no more than 5 pinholes after 4 hours of spraying. The spray-bar test is the method that ACM currently uses to certify many producers. One criterion for certification is less than 10% dampness on the inside of the front face shell and no more than 5 pinholes.

Hydrocarbon-based Water Repellent admixtures (“HCWRs”) can provide concrete and CMUs that perform well in reducing water penetration due to capillary suction; but, they are not as effective in preventing water penetration through pinholes. Thus, concrete and CMUs made with HCWRs typically provide satisfactory performance in the water uptake test; but, because they are not sufficiently effective at preventing water penetration through pinholes, typically do not provide satisfactory performance in the spray bar test with concrete mix designs that contain aggregate blends that do not fit tightly together enough.

Silane-siloxane (“SS”) can reduce water penetration through pinholes, and concrete and CMUs made with SS-containing mixes provide adequate performance in the spray bar test. However, concrete containing SS at typical doses does not provide fully satisfactory performance in the water uptake test, and often has uptake values over 60%.

Thus, even the best current concrete admixture formulations do not always provide fully satisfactory performance in both the water uptake test and the spray bar test. Moreover, to get optimum performance using current technology requires trial and error customization of mixes, constant monitoring, and costly batch to batch adjustments. Therefore there is a need for improved admixtures and formulations for water penetration resistant cement and concrete mixes, for water penetration resistant cements and concretes and for water penetration resistant products made therefrom, including but not limited to water penetration resistant CMUs.

### SUMMARY

Among other things the invention herein described provides, without limitation, each and all of the following. In this “Summary” section the phrases “any of the foregoing,” “any of the following” and “any of the foregoing or the following” refer to the other subject matter in the section and provide explicit support for the recitation of the subject matter thereafter set froth in combination with any of the “foregoing,” “following” or “forgoing or following” subject matter in the Summary. The numbering of certain paragraphs in this section is purely for convenience in grouping certain subject matter

1. Admixtures for making water penetration resistant cement and concrete mixes, comprising: (a) a hydrocarbon-based water repellent and (b) a silane-siloxane composition. In certain embodiments in this regard, the s/s weight ratio of (a) to (b) is from 98:2 (a):(b) to 40:60 (a):(b). In certain embodiments in this regard, the s/s weight ratio of (a) to (b) is from 95:5 (a):(b) to 50:50 (a):(b). In certain embodiments in this regard the s/s weight ratio of (a) to (b) is from 90:10 (a):(b) to 60:40 (a):(b).

2. Concrete and/or cement compositions, comprising: (a) a hydrocarbon-based water repellent and (b) a silane-siloxane composition.

In certain embodiments in this regard the concrete or cement compositions, comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

In certain embodiments in this regard, the concrete or cement compositions comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.10 to 0.90% (s/s hydratable cement binder) HCWR, and
0.03 to 0.25% (s/s hydratable cement binder) SS.

In certain embodiments in this regard the concrete or cement compositions comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.12 to 0.70% (s/s hydratable cement binder) HCWR, and
0.04 to 0.20% (s/s hydratable cement binder) SS.

3. Cured concrete or cement compositions, comprising: (a) a hydrocarbon-based water repellent and (b) a silane-siloxane composition.

In certain embodiments in this regard the cured concrete or cement compositions comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

In certain embodiments in this regard the cured concrete or cement compositions comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.10 to 0.90% (s/s hydratable cement binder) HCWR, and
0.03 to 0.25% (s/s hydratable cement binder) SS.

In certain embodiments in this regard the cured concrete or cement compositions comprise:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.12 to 0.70% (s/s hydratable cement binder) HCWR, and
0.04 to 0.20% (s/s hydratable cement binder) SS.

In certain embodiments the cured cement or concrete composition has a value of 10% or less dampness and 5 pinholes or less as determined by the Standard Spray Bar Test and 60% or less water uptake as determined by the Standard Water Uptake test.

4. CMUs made of a concrete or cement composition, comprising, (a) a hydrocarbon-based water repellent and (b) a silane-siloxane composition.

In certain embodiments in this regard the CMUs are made of a concrete or cement composition, comprising,
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

In certain embodiments in this regard the CMUs are made of a concrete or cement composition, comprising:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.10 to 0.90% (s/s hydratable cement binder) HCWR, and
0.03 to 0.25% (s/s hydratable cement binder) SS.

In certain embodiments in this regard the CMUs are made of a concrete or cement composition, comprising:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.12 to 0.70% (s/s hydratable cement binder) HCWR, and
0.04 to 0.20% (s/s hydratable cement binder) SS.

In certain embodiments in this regard the CMUs have a value of 10% or less dampness and 5 pinholes or less as determined by the Standard Spray Bar Test and 60% or less water uptake as determined by the Standard Water Uptake test.

5. Methods of making an admixture for concrete mixes, comprising, combining (a) a hydrocarbon-based water repellent and (b) a silane-siloxane composition. In certain embodiments in this regard, the s/s weight ratio of (a) to (b) is from 98:2 (a):(b) to 40:60 (a):(b). In certain embodiments in this regard, the s/s weight ratio of (a) to (b) is from 95:5 (a):(b) to 50:50 (a):(b). In certain embodiments in this regard the s/s weight ratio of (a) to (b) is from 90:10 (a):(b) to 60:40 (a):(b).

6. Methods of making a CMU made of a concrete or cement composition, comprising providing a concrete or cement composition comprised of:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

In certain embodiments in this regard the methods for making a CMU made of a concrete or cement composition, comprise providing a concrete or cement composition comprised of:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.10 to 0.90% (s/s hydratable cement binder) HCWR, and
0.03 to 0.25% (s/s hydratable cement binder) SS.

In certain embodiments in this regard the methods making a CMU made of a concrete or cement composition, comprise providing a concrete or cement composition comprised of:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.12 to 0.70% (s/s hydratable cement binder) HCWR, and
0.04 to 0.20% (s/s hydratable cement binder) SS.

In each and all of the foregoing regards, in certain embodiments the invention further provides, without limitation, the following.

7. Any of the foregoing or the following wherein the hydrocarbon based water repellent is one or more of a fatty acid derivative, a wax emulsion or a particulated polymer. In certain embodiment in this regard the hydrocarbon based water repellent is a fatty acid derivative. In certain embodiments in this regard the hydrocarbon based water repellent is a fatty acid derivative that is a C₈-C₃₀ fatty acid or a derivative thereof, including salts thereof.

In certain embodiments in this regard the hydrocarbon based water repellent is a fatty acid derivative of the following Formula FA1:

R_{FA}COO-A

wherein

R_{FA} is a C₇-C₂₉ alkyl(ene) group; and

A is H, a C₁-C₁₂ linear or branched alkyl group, an alkali or alkaline earth metal cation, a polyvalent cation, a glycerol moiety (e.g., a polyhydroxy alcohol), or a C₁-C₁₂ linear or branched alkyl or alkanol amine.

In certain embodiments in this regard the hydrocarbon based water repellent is one or more of a wax emulsion or a particulated polymer selected from the group consisting of polyepoxide, polystyrene-butadiene, polyvinyl acetate, polyacrylonitrile-butadiene, polyacrylic ester, polyvinylidene chloride-vinyl chloride, polyethylene-vinylacetate, polyurethane, acrylic latex, polymethacrylic ester, and copolymers of these polymers.

8. Any of the foregoing or the following, wherein the Silane-Siloxane is an aqueous alkoxysilane compound of the Formula SSI as follows:

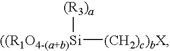

wherein:

each R₁ independently is a linear or branched C₁-C₃ alkyl;

R₃ is a linear or branched C₁-C₂₀ alkyl, or phenyl;

a is 0 or 1;

b is 1 or 2;

c is 1 to 18; and

X is H, Cl, Br, I, NH₂, SCN, CN, N₃, NHR, N(R)₂, N(R)₃ or aryl where b=1,

X is alkenyl where b=2;

X is Sₓ, x=1 to 6 where b=2 and c=1 to 6

X is a single bond where b=2 and c=1 to 12,

and partial condensation products thereof.

9. Any of the foregoing, comprising an aqueous alkoxysilane compound of formula SS1 and an organosilicon compound of the Formula OS1 as follows:

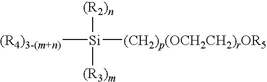

wherein:

each R₂ and R₃ independently are identical or different, linear or branched C₁-C₂₀ alkyl, or phenyl,

each R₄ independently is C₁-C₃ alkoxy, (OCH₂CH₂)ᵣOR₅ or

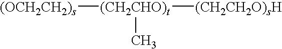

wherein s=3 to 50 and t=3 to 25;

R₅ is H, C₁-C₂₀ alkyl, C₂-C₃₆ alkenyl, C₅-C₈ cycloalkyl, C₇-C₃₆ aralkyl or —(OCH₂CH₂)ₛ—(CH₂CHO)ₜ—(CH₂CH₂O)ₛH

m is 0, 1 or 2;

n is 0, 1 or 2 provided that (m+n)=1 or 2, where p=0; and where p is not 0, (m+n)=0, 1 or 2;

p is 0, 1, 2 or 3;

r is an integer from 0 to 50.

10. Any of the foregoing or the following, comprising an emulsion with a disperse phase having an average particle diameter of 0.3 to 1.1 micrometer and a width of particle size distribution of 1.3 or less.

11. Any of the foregoing or the following, further comprising any one or more of hydrolysable organosilicon compounds, ionic or nonionic surfactants and/or emulsifiers.

12. Any of the foregoing or the following, further comprising any one or more of a dispersant, a plasticizer, a lubricant, a salt scavenger and a viscosity modifier.

13. Any of the foregoing or the following, further comprising on a solid/solid basis 0 to 50 parts per 100 parts of water repellent material any one or more of a dispersant, a plasticizer, a lubricant, a salt scavenger and a viscosity modifier.

Any of the foregoing or the following, further comprising on a solid/solid basis 0 to 30 parts per 100 parts of water repellent material any one or more of a dispersant, a plasticizer, a lubricant, a salt scavenger and a viscosity modifier.

Any of the foregoing, further comprising on a solid/solid basis 0 to 20 parts per 100 parts of water repellent material any one or more of a dispersant, a plasticizer, a lubricant, a salt scavenger and a viscosity modifier.

14. Any of the foregoing, further comprising one or more additional hydrophobic compounds.

15. Any of the foregoing, further comprising any one or more of calcium stearate, zinc stearate, magnesium stearate and aluminum stearate.

### GLOSSARY

The following explanations of certain terms used herein are set forth by way of illustration and explication of their use in describing and understanding the invention.

a and an—As used herein both mean one or more than one, without limitation and throughout the disclosure. Nowhere herein is either article used to mean only one.

admixture—a composition for use in formulating concrete mixes; a composition for mixing with other components to make concrete, in embodiments, particularly concrete for making concrete masonry units.

calcium stearate dispersion—a dispersion comprising calcium stearate, calcium palmitate and optionally, other calcium salts of C₈-C₃₀ fatty acids and combinations thereof. Calcium stearate dispersions are abbreviated “CSD” herein. By extension, the term also includes other stearate salts, including for instance, zinc, magnesium, or aluminum stearate dispersions. Stearate dispersions are HCWRs.

concrete—material comprised of cement, often but not always containing other cementitious materials such as fly ash and slag cement, aggregate(s), which may be coarse aggregates such as gravel, limestone, or granite, and/or fine aggregates such as sand, other components such as chemical admixtures, and water.

concrete masonry units—pre-formed units made of concrete. The units typically are made in molds of low slump concrete, optionally cured by heat and moisture under controlled conditions, and then dried. A familiar unit form factor for concrete masonry units in the construction industry is the 8×8×16-inch block; but, concrete masonry units can be made in virtually any shape and any size including concrete pavers used for sidewalks and pavements, segmental units for segmental retaining walls, concrete pipes used for drainage control, and concrete tiles for roofing, walls and decorative applications, to name just a few. Standard units often are made of Portland cement, gravel, sand, and water, with several other ingredients to improve various properties of the concrete, such as air-entraining agents, coloring pigment, and water repellent.

CSD—calcium stearate dispersion, see above.

HCWR—Hydrocarbon-based Water Repellent.

Hydratable Cement Binder—materials that react in the presence of water to form a hardened binder for concrete including Portland cement, blended cement, slag cement, fly ash and other pozzolanic materials.

Hydrocarbon-based Water Repellent—a hydrophobic hydrocarbon, such as a fatty acid derivative or a particulated hydrocarbon polymer. Salient examples of the former include dispersions of micron-size solid particles of divalent salts of stearate, palmitate and other fatty acids, and tall oil, a mixture of oleic, linoleic and rosin acids. Examples of the latter include polymer latexes, such as those described in U.S. Pat. No. 5,922,124 of Supplee.

IWR—integral water repellant.

oz/cwt—fluid ounces per hundred pounds of cementitious materials.

or—is used herein in the inclusive sense. Thus, for instance, as used herein, a, b or c means: any one (or more) of—a alone; b alone; c alone; a and b together; a and c together; and a and b and c together.

SS—Silane-Siloxane.

s/s—solid to solid weight ratio, typically expressed in percent or as a ratio. For water-based aqueous mixtures including solutions, emulsions and dispersions, the ‘solids’ include all of the components other than the water. In the case of some solutions and emulsions the ‘solids’ may actually be in a liquid phase at room temperature even after the removal of water.

Standard Performance Criteria for Water Repellent CMU—The performance criteria for determining acceptable water penetration resistance of Water Repellent CMU described in National Concrete Masonry Association (NCMA) TEK 19-7 Characteristics of Concrete Masonry Units with Integral Water Repellent, 2008. (Copy submitted herewith.)

Standard Spray Bar Test—The test for evaluating the resistance of concrete masonry units to moisture migration when a stream of water is applied to its outer face described in National Concrete Masonry Association TEK 19-7 Characteristics of Concrete Masonry Units with Integral Water Repellent, 2008 and NCMA Method CMU-WR2-08, Standard Test Method for Spray Bar Test of Concrete Masonry Units, December 2008. (Copy submitted herewith.)

Standard Water Uptake Test—The test for evaluating the resistance of concrete masonry units to vertical water uptake described in National Concrete Masonry Association TEK 19-7 Characteristics of Concrete Masonry Units with Integral Water Repellent, 2008 and NCMA Method CMU-WR3-08, Standard Test Method for Assessing Water Uptake Potential of Concrete Masonry Units, December 2008. (Copy submitted herewith.)

Spray Bar Test—A test for evaluating the resistance of concrete masonry units to moisture migration when a stream of water is applied to its outer face.

Water Uptake Test—A test for evaluating the resistance of a hollow concrete masonry unit to vertical moisture migration due to capillary action.

### DESCRIPTION

### Concrete Mixes

Masonry concrete mixes are cementitious compositions containing 4-25% (s/s total dry weight) hydratable cement binder, 74-95% (s/s total dry weight) of a relatively fine aggregate, sufficient water to make a homogeneous mixture (typically, 15 to 45% of the hydratable cement binder), and optionally, 0.5-5% (s/s hydratable cement binder) coloring pigment, and 0.01-2% admixture (s/s hydratable cement binder). In this case, “relatively fine aggregate” is defined as an aggregate blend or particle batch containing aggregates as fine or finer than Size Number 8 Coarse Aggregated as defined in ASTM C 33-07, and in which the final aggregate blend is virtually all less than 0.5 inch diameter and having less than 5% of the aggregate with diameters greater than or equal to 0.375 inch. This includes “concrete sand” and “masonry sand”.

Admixtures

In certain embodiments the invention provides admixtures for making water repellent concrete mixes and products, such as CMUs. In certain embodiments the admixtures are mixtures that comprise an HCWR and an SS. In certain embodiments admixtures are aqueous. In certain embodiments the admixtures comprise 40-98% (s/s) HCWR and 2-60% (s/s) SS materials, wherein :% (s/s)” refers to the non-aqueous components of the ingredients and is equivalent to percentage calculated on a solids on solids basis. In certain embodiments, admixtures optionally comprise other ingredients. In certain embodiments, s/s weight ratio of (a) HCWR to (b) SS from 98:2 (a):(b) to 40:60 (a):(b). In certain embodiments, the ratio is from 95:5 (a):(b) to 50:50 (a):(b). In certain embodiments, the ratio is from 90:10 (a):(b) to 60:40 (a):(b).

In certain embodiments admixtures comprise other ingredients in 0-50 parts per 100 parts of total water-repellent ingredients. In certain embodiments admixtures comprise other ingredients in 0-30 parts per 100 parts of total water-repellent ingredients. In certain embodiments admixtures comprise other ingredients in 0-20 parts per 100 parts of total water-repellent ingredients. In certain embodiments the admixtures comprise other ingredients that have other functions besides water-repellency in the admixture. In certain embodiments, the admixtures comprise any one or more of dispersants, plasticizers, lubricants, color enhancers, salt scavengers and/or viscosity modifiers.

In certain embodiments, admixtures are manufactured by combining ingredients in a suitably sized vessel and mixing, stirring or blending until the mixture is homogeneous.

Producing Mixes and CMUs

Typically, all of the ingredients are combined in a mechanical pan or ribbon mixer and thoroughly blended until the mix is homogeneous. The mix is then fed into a machine that makes CMUs.

CMUs

Concrete masonry units (CMUs) are manufactured concrete articles made from concrete mixes with little or no slump that are fed into molds, vibrated and compacted such that when the mold is removed the article is free-standing without slumping or losing structural integrity. Alternatively, in the case of roof tile, the concrete mix can be extruded onto contoured pallets which serve as the molds. Also alternatively, in the case of simulated stone slabs, the concrete mix may have some slump and is fed into a mold, typically made of pliable polymer, which serves as the carrier for the CMU during curing. Thereafter, the articles are cured, typically for 6 to 72 hours or more, optionally with heat or additional moisture (typically supplied as steam, mist or water vapor).

CMUs are typically 1 to 200 lbs in weight and are used in a wide variety of applications including but not limited to standard and specialty hollow and solid concrete block, hollow and solid architectural block, segmental retaining wall units, paving units and slabs, grid paving units, roof tile, and simulated stone slabs. The specialty hollow and solid concrete block include units for bond beams, lintels, and other specialty functions. The hollow and solid architectural block and segmental retaining wall units often have an architectural finish on one or more of the exposed surfaces including but not limited to split face, ground face, sand-blast face, or burnished face.

### Illustrative Embodiments

Certain embodiments of the present invention relate to, among other things, admixtures for making water penetration resistant concrete mixes, concretes and concrete masonry units, to methods for making and for using the admixtures, to methods for making the concrete mixes, concretes and concrete masonry units, and to water penetration resistant concrete and concrete masonry units. In certain embodiments, the water resistance is less than 10% and less than 5 pinholes measured by the Standard Spray Bar Test, and less than 60% water uptake measured by the Standard Water Uptake Test.

Embodiments of the invention provide concrete compositions comprising (a) a hydrocarbon-based water repellent material and (b) a silane-siloxane material, concrete and CMUs made therefrom, particularly concrete and CMUs that provide superior results in both the Water Uptake and the Spray Bar tests of water penetration resistance, especially that meet or exceed NCMA standards for both tests. Further embodiments provide admixtures for making the concrete compositions, concretes and CMUs, processes for making the admixtures, and processes for making the compositions, concretes and CMUs, among other things.

Embodiments of the invention provide admixtures comprising: (a) a hydrocarbon-based water repellent material; (b) a silane-siloxane material; and, optionally, (c) auxiliary materials that provide properties other than water-repellency. Embodiments provide admixtures for making water resistant cement and concrete mixes, comprising: (a) a hydrocarbon-based water repellent and (b) a silane-siloxane composition. In certain embodiments, s/s weight ratio of (a) HCWR to (b) SS from 98:2 (a):(b) to 40:60 (a):(b). In certain embodiments, the ratio is from 95:5 (a):(b) to 50:50 (a):(b). In certain embodiments, the ratio is from 90:10 (a):(b) to 60:40 (a):(b).

Embodiments of the invention provide concrete or cement compositions comprising: (a) a hydrocarbon-based water repellent and (b) a silane-siloxane composition. Embodiments provide concrete or cement composition, comprising: 4-25% (s/s total dry weight) hydratable cement binder; 74-95% (s/s total dry weight) relatively fine aggregate which is an aggregate blend or particle batch containing aggregates as fine or finer than Size Number 8 coarse aggregates as defined in ASTM C 33-07; and 0.10 to 1.25% (s/s hydratable cement binder) (equivalent to 0.005-0.313% (s/s total dry weight)) admixture comprising: (a) a hydrocarbon-based water repellent and (b) a silane-siloxane composition. In certain embodiments, the concrete compositions comprise (a) 0.08 to 1.23% (s/s hydratable cement binder) HCWR and (b) 0.02 to 0.30% (s/s hydratable cement binder) SS. In certain embodiments, the concrete compositions comprise (a) 0.10 to 0.90% (s/s hydratable cement binder) HCWR and (b) 0.03 to 0.25% (s/s hydratable cement binder) SS. In certain embodiments, the concrete compositions comprise (a) 0.12 to 0.70% (s/s hydratable cement binder) HCWR and (b) 0.04 to 0.20% (s/s hydratable cement binder) SS.

Embodiments of the invention provide cured concrete or cement compositions comprising: (a) a hydrocarbon-based water repellent and (b) a silane-siloxane composition. Embodiments provide cured concrete or cement compositions comprising, relative to total dry weight: 4-25% hydratable cement binder; 74-95% relatively fine aggregate which is an aggregate blend or particle batch containing aggregates as fine or finer than Size Number 8 coarse aggregates as defined in ASTM C 33-07; and 0.005-0.313% admixture comprising: (a) a hydrocarbon-based water repellent and (b) a silane-siloxane composition.

Embodiments provide cured cement or concrete composition, such as those described above, and elsewhere herein, having a value of 10% or dampness and 5 pinholes or less as determined by the Standard Spray Bar Test and 60% or less water uptake as determined by the Standard Water Uptake test.

Embodiments of the invention provide CMUs made of a concrete or cement composition, comprising, (a) a hydrocarbon-based water repellent and (b) a silane-siloxane composition. Embodiments provide CMUs made of a concrete or cement composition, comprising, relative to total dry weight: 4-25% hydratable cement binder; 74-95% relatively fine aggregate which is an aggregate blend or particle batch containing aggregates as fine or finer than Size Number 8 coarse aggregates as defined in ASTM C 33-07; and 0.005-0.313% admixture comprising: (a) a hydrocarbon-based water repellent and (b) a silane-siloxane composition.

Embodiments provide CMUs, such as those described above, and elsewhere herein, having a value of 10% or dampness and 5 pinholes or less as determined by the Standard Spray Bar Test and 60% or less water uptake as determined by the Standard Water Uptake test.

Embodiments of the invention provide methods of making an admixture for concrete mixes, comprising, blending (a) a hydrocarbon-based water repellent and (b) a silane-siloxane composition.

Embodiments of the invention provide methods for making CMUs of a concrete or cement composition, comprising providing a concrete or cement composition comprised of, relative to total dry weight: 4-25% hydratable cement binder; 74-95% relatively fine aggregate which is an aggregate blend or particle batch containing aggregates as fine or finer than Size Number 8 coarse aggregates as defined in ASTM C 33-07; and 0.01-1.0% admixture comprising: (a) a hydrocarbon-based water repellent and (b) a silane-siloxane composition.

Hydrocarbon-Based Water Repellent Materials

Various embodiments described herein relate to hydrocarbon-based water repellent materials, as illustratively described below. HCWRs have been used in concrete admixtures since Integral Water-Repellent (IWR) admixtures were introduced in “Dry-Block” products by Forrer Industries in about 1983. Today most—if not all—masonry admixture providers have a product that contains HCWRs. The major ingredient in these admixtures generally is a hydrocarbon-based hydrophobic material suspended in water. The most commonly used is Calcium Stearate Dispersion (CSD) which is essentially a mixture of micron-size solid particles of calcium stearate, palmitate and other fatty acids held in an aqueous dispersion containing dispersants and surfactants. CSDs are readily available commercially.

Some manufacturers use other fatty acids, such as tall oil which contains oleic, linoleic and rosin acids, either alone or in combination with CSD. Commercially available proprietary admixtures of this sort also often contain various polymer latexes that fall into the category of “particulated polymers” such as those described in U.S. Pat. No. 5,922,124 of Supplee (notwithstanding Supplee's distinction to the contrary, these are hydrophobic compounds and should be included in the HCWR category).

In accordance with the invention herein disclosed, HCWR materials include all of the following.

HCWR/Fatty Acid Derivatives

Fatty acid derivatives for use in compositions in accordance with the invention, including admixtures and formulations include CSD and other derivatives of fatty acids, such as those described in the published US patent application of Karkare, publication number 2002/0005149 A1 and in U.S. Pat. No. 5,460,648 to Walloch. Embodiments of the invention comprise CSD. Embodiments of the invention comprise other fatty acid derivatives. Embodiments of the invention comprise both CSD and other fatty acid derivatives.

In embodiments the HCWR is one or more of a fatty acid derivative, a wax emulsion or a particulated polymer. In embodiments it is a fatty acid derivative. In embodiments it is a C₈-C₃₀ fatty acid or a derivative thereof, including salts thereof.

In embodiments it is a fatty acid derivative of the following Formula FA1:

R_{FA}COO-A

wherein

R_{FA} is a C₇-C₂₉ alkyl(ene) group; and

A is H, a C₁-C₁₂ linear or branched alkyl group, an alkali or alkaline earth metal cation, a polyvalent cation, a glycerol moiety (e.g., a polyhydroxy alcohol), or a C₁-C₁₂ linear or branched alkyl or alkanol amine.

HCWR/Particulated Polymers

Particulated polymers for use in accordance with embodiments of the invention include polymer latexes and other particulated polymers described in U.S. Pat. No. 5,922,124 of Supplee. In embodiments particulated polymers are particulated polymers of any one or more of polyepoxide, polystyrene-butadiene, polyvinyl acetate, polyacrylonitrile-butadiene, polyacrylic ester, polyvinylidene chloride-vinyl chloride, polyethylene-vinylacetate, polyurethane, acrylic latex, polymethacrylic ester, and copolymers of these polymers. In embodiments the particulated polymers have a size range of about 0.01 angstroms to about 10,000 angstroms. In embodiments the particulated polymers have a size range of about 0.05 angstroms to about 15,000 angstroms. In embodiments the particulated polymers are any one or more of polyepoxide, polystyrene-butadiene, polyvinyl acetate, polyacrylonitrile-butadiene, polyacrylic ester, polyurethane, and acrylic latex and have a size range of about 0.05 angstroms to about 15,000 angstroms.

HCWR/Other Hydrophobic Materials

Among other hydrophobic material of embodiments of the invention are wax emulsions and other aqueous based hydrophobic materials.

Silane-Siloxane Materials

Various embodiments of the invention relate to silane-siloxane emulsions, illustratively described as follows. Silane-Siloxane emulsions are a relatively new class of admixtures for improving the water penetration resistance of concretes. Silane-Siloxane emulsions are described, for instance, in U.S. Pat. No. 6,139,622 of Gobel, which is herein incorporated by reference in its entirety particularly in parts pertinent to SS compositions and use thereof. Originally they were used exclusively as penetrating sealers applied externally to masonry buildings after construction, until recently. A few years ago, Degussa started selling a concentrated (50% active) SS emulsion, Rheopel Plus, as an admixture for making integrally water resistant concretes. The Rheopel Plus formulation is much the same base used in the externally penetrating sealers.

The dosages of Rheopel Plus typically used in integral water repellent CMU applications (4 to 6 fluid oz per 100 lbs of hydratable cement binder; 0.25 to 0.37% SS emulsion and 0.12 to 0.19% SS (s/s hydratable cement binder)) considerably reduce water penetration through the pinholes. However, it does not produce concrete as water-repellant as do HCWR materials.

In embodiments the Silane-Siloxane is an aqueous alkoxysilane compound of the Formula SSI as follows:

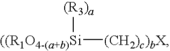

wherein:

each R₁ independently is a linear or branched C₁-C₃ alkyl;

R₃ is a linear or branched C₁-C₂₀ alkyl, or phenyl;

a is 0 or 1;

b is 1 or 2;

c is 1 to 18; and

X is H, Cl, Br, I, NH₂, SCN, CN, N₃, NHR, N(R)₂, N(R)₃ or aryl where b=1,

X is alkenyl where b=2;

X is Sₓ, x=1 to 6 where b=2 and c=1 to 6

X is a single bond where b=2 and c=1 to 12,

and partial condensation products thereof.

In embodiments the silane-siloxane is an aqueous alkoxysilane compound of formula SS1 and an organosilicon compound of the Formula OS1 as follows:

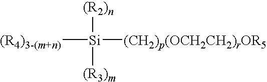

wherein:

each R₂ and R₃ independently are identical or different, linear or branched C₁-C₂₀ alkyl, or phenyl,

each R₄ independently is C₁-C₃ alkoxy, (OCH₂CH₂)ᵣOR₅ or

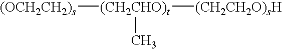

wherein s=3 to 50 and t=3 to 25;

R₅ is H, C₁-C₂₀ alkyl, C₂-C₃₆ alkenyl, C₅-C₈ cycloalkyl, C₇-C₃₆ aralkyl or —(OCH₂CH₂)ₛ—(CH₂CHO)ₜ—(CH₂CH₂O)ₛH

m is 0, 1 or 2;

n is 0, 1 or 2 provided that (m+n)=1 or 2, where p=0; and where p is not 0, (m+n)=0, 1 or 2;

p is 0, 1, 2 or 3;

r is an integer from 0 to 50.

In embodiments the concrete compositions comprise (a) 0.08 to 1.23% (s/s hydratable cement binder) HCWR and (b) 0.02 to 0.30% (s/s hydratable cement binder) SS.

In embodiments the concrete compositions comprise (a) 0.10 to 0.90% (s/s hydratable cement binder) HCWR and (b) 0.03 to 0.25% (s/s hydratable cement binder) SS.

In embodiments the concrete compositions comprise (a) 0.12 to 0.70% (s/s hydratable cement binder) HCWR and (b) 0.04 to 0.20% (s/s hydratable cement binder) SS.

Other Ingredients

Auxiliary materials (other ingredients) that have other functions that can be included in admixtures and mixes include but are not limited to any one or more of dispersants, plasticizers, lubricants, color enhancers, salt scavengers and/or viscosity modifiers.

In embodiments the other ingredients comprise 0.00 to 0.16% of the concrete composition. In embodiments the other ingredients comprise 0.00 to 0.09% of the concrete composition. In embodiments the other ingredients comprise 0.00 to 0.6% of the concrete composition.

### EXAMPLES

The following examples are illustrative of particular aspects and embodiments of the invention and in no way limit its scope. Many other aspects and embodiments of the invention will be immediately clear to those skilled in the art from the contents of this disclosure, and a full understanding of the invention herein disclosed can be obtained only by careful scrutiny of the present disclosure in all its details as it should be understood by the person skilled and knowledgeable in the pertinent arts.

### Example 1

### Standard Spray Bar Test

The test for evaluating the resistance of concrete masonry units to moisture migration when a stream of water is applied to its outer face described in National Concrete Masonry Association TEK 19-7 Characteristics of Concrete Masonry Units with Integral Water Repellent, 2008 and NCMA Method CMU-WR2-08, Standard Test Method for Spray Bar Test of Concrete Masonry Units, December 2008.

### Example 2

### Standard Water Uptake Test

The test for evaluating the resistance of concrete masonry units to vertical water uptake described in National Concrete Masonry Association TEK 19-7 Characteristics of Concrete Masonry Units with Integral Water Repellent, 2008 and NCMA Method CMU-WR3-08, Standard Test Method for Assessing Water Uptake Potential of Concrete Masonry Units, December 2008.

Examples 3-6 show the results of tests on the water resistance of concrete blocks of several formulations made by three different producers, using HCWR alone, SS alone or HCWR together with SS in accordance with embodiments of the invention. As can be seen from the tables below, all blocks had excessive pinholes when the regular HCWR was used, and the best results were obtained using the combinations of HCWR and SS herein described.

### Example 3

### Medium Weight Concrete Block

Medium weight concrete block were manufactured with a concrete mix containing the following (all as % s/s total dry weight of the mix): 10% cement, 2% fly ash, 34% lightweight aggregates, 18% limestone and 36% concrete sand. The batches contained various amounts of HCWR and SS as detailed in the Table 1 below.

TABLE 1

| Batch | A | B | C | D | E |
|---|---|---|---|---|---|
| Admixture % (s/s hy- | | | | | |
| dratable cement binder) | | | | | |
| HCWR | 1.22 | — | — | 0.31 | 0.31 |
| SS | — | 0.12 | 0.15 | 0.09 | 0.12 |
| Spray-Bar (Front | | | | | |
| Face Shell) | | | | | |
| Dampness % | 15 | 1 | 0 | 4 | 0 |
| Pinholes | 8 | 0 | 0 | 2 | 0 |
| Water Uptake | | | | | |
| % of Total absorption | 34 | 73 | 61 | 55 | 49 |
| at 24 hours | | | | | |
| Physical Properties | | | | | |
| Density (pcf) | 107.4 | 106.6 | 106.3 | 106.5 | 107.0 |
| Absorption (pcf) | 9.1 | 9.2 | 9.0 | 9.2 | 8.7 |

This results in column A show that HCWR used by itself provides a good water uptake value (under 60%); but, failed the spray-bar test because of excessive dampness (15% versus an allowed maximum of 10%) and excessive pinholes (8 versus an allowed maximum of 5). The results in columns B and C show that SS used by itself provides a good value in the spray-bar test (less than 10% dampness and a maximum of 5 pinholes); but, poor values in the water uptake test (over 60%). The results in columns D and E show that combinations of HCWR and SS provided good results in the spray-bar test (less than 10% dampness and a maximum of 5 pinholes) and good results in the water uptake test (under 60%).

### Example 4

### Normal Weight Concrete Block/Cement, -Limestone

Normal weight concrete block were manufactured with a concrete mix containing the following (all as % s/s total dry weight of the mix): 10% cement and 90% limestone. The batches contained various amounts of HCWR and SS as detailed in Table 2 below.

TABLE 2

| Batch | F | G | H | I |
|---|---|---|---|---|
| Admixture % | | | | |
| (s/s hydratable cement binder) | | | | |
| HCWR | 0.76 | — | 0.31 | 0.38 |
| SS | — | 0.12 | 0.08 | 0.09 |
| Spray-Bar (Front Face Shell) | | | | |
| Dampness % | 80 | 1 | 1 | 2 |
| Pinholes | 20 | 0 | 0 | 2 |
| Water Uptake | | | | |
| % of Total absorption at 24 hours | 62 | 63 | 46 | 41 |
| Physical Properties | | | | |
| Density (pcf) | 131.8 | 131.9 | 132.6 | 133.0 |
| Absorption (pcf) | 9.5 | 9.4 | 9.1 | 9.0 |

The results in column F show that block made with HCWR alone failed the spray-bar test because of excessive dampness (80% versus an allowed maximum of 10%) and excessive pinholes (20 versus an allowed maximum of 5) and performed poorly in the water uptake test as well, with values over 60%. The results in column G show that block produced using SS by itself had good spray-bar results (less than 10% dampness and a maximum of 5 pinholes) but unsatisfactory performance in the water uptake test (over 60%). The results in columns H and I show that block made with HCWR and SS in combination had both good spray-bar results (less than 10% dampness and a maximum of 5 pinholes) and good water uptake values (under 60%)

### Example 5

### Normal Weight Concrete Block/Cement-Limestone-Limestone Screenings

Normal weight concrete block were manufactured with a concrete mix containing the following (all as % s/s total dry weight of the mix): 8% cement, 71% limestone, and 21% limestone screenings. The batches contained various amounts of HCWR and SS as detailed in Table 3 below.

TABLE 3

| Batch | J | K | L | M |
|---|---|---|---|---|
| Admixture % | | | | |
| (s/s hydratable cement binder) | | | | |
| HCW R | 0.92 | — | — | 0.46 |
| SS | — | 0.12 | 0.19 | 0.09 |
| Spray-Bar (Front Face Shell) | | | | |
| Dampness % | 60 | 2 | 0 | 1 |
| Pinholes | 16 | 1 | 1 | 0 |
| Water Uptake | | | | |
| % of Total absorption at 24 hours | 68 | 67 | 63 | 51 |
| Physical Properties | | | | |
| Density (pcf) | 130.2 | 131.6 | 132.8 | 130.3 |
| Absorption (pcf) | 9.7 | 9.2 | 8.9 | 10.4 |

The results in column J show that block made with HCWR used by itself failed the spray-bar test because of both excessive dampness (60% versus an allowed maximum of 10%) and excessive pinholes (16 versus an allowed maximum of 5), and had poor water uptake values (over 60%). The results in columns K and L show that block made using SS alone had good spray-bar results (less than 10% dampness and a maximum of 5 pinholes) but had water uptake values in excess of 60%. The results in column M show that block made using HCWR and SS in combination had both good spray-bar results (less than 10% dampness and a maximum of 5 pinholes) and good water uptake values (under 60%).

### Example 6

### Medium Weight Concrete Block

Medium weight concrete block were manufactured with a concrete mix containing the following (all as % s/s total dry weight of the mix): 10% cement, 3% fly ash, 48% lightweight aggregates, and 39% concrete sand. The batches contained various amounts of HCWR and SS as detailed in Table 4 below.

TABLE 4

| Batch | N | O | P |
|---|---|---|---|
| Admixture % | | | |
| (s/s hydratable cement binder) | | | |
| HCWR | 1.22 | — | 0.24 |
| SS | — | 0.12 | 0.09 |
| Spray-Bar (Front Face Shell) | | | |
| Dampness % | 19 | 5 | 5 |
| Pinholes | 19 | 2 | 2 |
| Water Uptake | | | |
| % of Total absorption at 24 hours | 29 | 66 | 46 |
| Physical Properties | | | |
| Density (pcf) | 106.7 | 104.9 | 105.9 |
| Absorption (pcf) | 9.7 | 10.9 | 9.9 |

The results in column N show that block made with HCWR used by itself provides a good water uptake value (under 60%); but, fails the spray-bar test because of both excessive dampness (19% versus an allowed maximum of 10%) and excessive pinholes (19 versus an allowed maximum of 5). The results in column O show that block made using SS alone had good spray-bar test results (less than 10% dampness and a maximum of 5 pinholes) but had unsatisfactory water uptake values, in excess of 60%. The results in column P show that block made using HCWR and SS in combination had both good spray-bar results (less than 10% dampness and a maximum of 5 pinholes) and good water uptake values (under 60%).

1.-37. (canceled)

38. An admixture for making water penetration resistant cement and concrete mixes, comprising: (a) a hydrocarbon-based water repellent (HCWR) and (b) a silane-siloxane composition (SS).

39. An admixture according to claim 38, wherein the s/s weight ratio of (a) to (b) is from 98:2 (a):(b) to 40:60 (a):(b).

40. An admixture according to claim 38, wherein the hydrocarbon based water repellent is one or more of a fatty acid derivative, a wax emulsion or a particulated polymer.

41. An admixture according to claim 40, wherein the hydrocarbon based water repellent is a wax emulsion or a particulated polymer selected from the group consisting of polyepoxide, polystyrene-butadiene, polyvinyl acetate, polyacrylonitrile-butadiene, polyacrylic ester, polyvinylidene chloride-vinyl chloride, polyethylene-vinylacetate, polyurethane, acrylic latex, polymethacrylic ester, and copolymers of these polymers.

42. An admixture according to claim 38, wherein the hydrocarbon based water repellent is a fatty acid derivative of the following Formula FA1:
R_{FA}COO-A
wherein
R_{FA} is a C₇-C₂₉ alkyl or alkylene group; and
A is H, a C₁-C₁₂ linear or branched alkyl group, an alkali or alkaline earth metal cation, a polyvalent cation, a glycerol moiety (e.g., a polyhydroxy alcohol), or a C₁-C₁₂ linear or branched alkyl or alkanol amine.

43. An admixture according to claim 38, wherein the Silane-Siloxane is an aqueous alkoxysilane compound of the Formula SSI as follows: 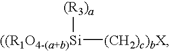
wherein:
each R₁ independently is a linear or branched C₁-C₃ alkyl;
R₃ is a linear or branched C₁-C₂₀ alkyl, or phenyl;
a is 0 or 1;
b is 1 or 2;
c is 1 to 18; and
X is H, Cl, Br, I, NH₂, SCN, CN, N₃, NHR, N(R)₂, N(R)₃ or aryl where b=1,
X is alkenyl where b=2;
X is Sₓ, x=1 to 6 where b=2 and c=1 to 6
X is a single bond where b=2 and c=1 to 12,
and partial condensation products thereof.

44. An admixture according to claim 42, wherein the Silane-Siloxane is an aqueous alkoxysilane compound of the Formula SSI as follows: 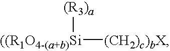
wherein:
each R₁ independently is a linear or branched C₁-C₃ alkyl;
R₃ is a linear or branched C₁-C₂₀ alkyl, or phenyl;
a is 0 or 1;
b is 1 or 2;
c is 1 to 18; and
X is H, Cl, Br, I, NH₂, SCN, CN, N₃, NHR, N(R)₂, N(R)₃ or aryl where b=1,
X is alkenyl where b=2;
X is Sₓ, x=1 to 6 where b=2 and c=1 to 6
X is a single bond where b=2 and c=1 to 12,
and partial condensation products thereof.

45. An admixture according to claim 38, further comprising any one or more of a hydrolysable organosilicon compounds, ionic or nonionic surfactants and/or emulsifiers.

46. An admixture according to claim 38, further comprising an aqueous alkoxysilane compound of formula SS1 and an organosilicon compound of the Formula OS1 as follows: 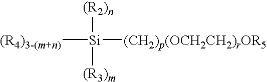
wherein:
each R₂ and R₃ independently are identical or different, linear or branched C₁-C₂₀ alkyl, or phenyl,
each R₄ independently is C₁-C₃ alkoxy, (OCH₂CH₂)ᵣOR₅ or 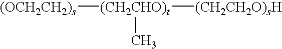
wherein:
s=3 to 50 and t=3 to 25;
R₅ is H, C₁-C₂₀ alkyl, C₂-C₃₆ alkenyl, C₅-C₈ cycloalkyl, C₇-C₃₆ aralkyl or —(OCH₂CH₂)ₛ—(CH₂CHO)ₜ—(CH₂CH₂O)ₛH
m is 0, 1 or 2;
n is 0, 1 or 2 provided that (m+n)=1 or 2, where p=0; and where p is not 0, (m+n)=0, 1 or 2;
p is 0, 1, 2 or 3;
r is an integer from 0 to 50.

47. An admixture according to claim 38, further comprising any one or more of a dispersant, a plasticizer, a lubricant, a salt scavenger, or a viscosity modifier.

48. A concrete masonry unit (CMU) made of a concrete or cement composition, comprising, (a) a hydrocarbon-based water repellent (HCWR) and (b) a silane-siloxane (SS) composition.

49. A CMU according to claim 48 made of a concrete or cement composition, comprising,
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

50. A CMU according to claim 48, wherein the hydrocarbon based water repellent is one or more of a fatty acid derivative, a wax emulsion or a particulated polymer.

51. A CMU according to claim 50, wherein the hydrocarbon based water repellent is wax emulsion or a particulated polymer selected from the group consisting of polyepoxide, polystyrene-butadiene, polyvinyl acetate, polyacrylonitrile-butadiene, polyacrylic ester, polyvinylidene chloride-vinyl chloride, polyethylene-vinylacetate, polyurethane, acrylic latex, polymethacrylic ester, and copolymers of these polymers.

52. A CMU according to claim 48, wherein the hydrocarbon based water repellent is a fatty acid derivative of the following Formula FA1:
R_{FA}COO-A
wherein
R_{FA} is a C₇-C₂₉ alkyl(ene) group; and
A is H, a C₁-C₁₂ linear or branched alkyl group, an alkali or alkaline earth metal cation, a polyvalent cation, a glycerol moiety (e.g., a polyhydroxy alcohol), or a C₁-C₁₂ linear or branched alkyl or alkanol amine.

53. A CMU according to claim 48, wherein the Silane-Siloxane is an aqueous alkoxysilane compound of the Formula SSI as follows: 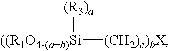
wherein:
each R₁ independently is a linear or branched C₁-C₃ alkyl;
R₃ is a linear or branched C₁-C₂₀ alkyl, or phenyl;
a is 0 or 1;
b is 1 or 2;
c is 1 to 18; and
X is H, Cl, Br, I, NH₂, SCN, CN, N₃, NHR, N(R)₂, N(R)₃ or aryl where b=1,
X is alkenyl where b=2;
X is Sₓ, x=1 to 6 where b=2 and c=1 to 6
X is a single bond where b=2 and c=1 to 12,
and partial condensation products thereof.

54. A CMU according to claim 52, wherein the Silane-Siloxane is an aqueous alkoxysilane compound of the Formula SSI as follows: 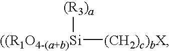
wherein:
each R₁ independently is a linear or branched C₁-C₃ alkyl;
R₃ is a linear or branched C₁-C₂₀ alkyl, or phenyl;
a is 0 or 1;
b is 1 or 2;
c is 1 to 18; and
X is H, Cl, Br, I, NH₂, SCN, CN, N₃, NHR, N(R)₂, N(R)₃ or aryl where b=1,
X is alkenyl where b=2;
X is Sₓ, x=1 to 6 where b=2 and c=1 to 6
X is a single bond where b=2 and c=1 to 12,
and partial condensation products thereof.

55. A CMU according to claim 48, further comprising any one or more of a hydrolysable organosilicon compounds, ionic or nonionic surfactants and/or emulsifiers.

56. A CMU according to claim 48, further comprising an aqueous alkoxysilane compound of formula SS1 and an organosilicon compound of the Formula OS1 as follows: 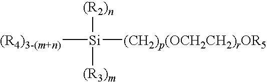
wherein:
each R₂ and R₃ independently are identical or different, linear or branched C₁-C₂₀ alkyl, or phenyl,
each R₄ independently is C₁-C₃ alkoxy, (OCH₂CH₂)ᵣOR₅ or 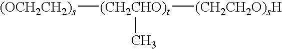
wherein:
s=3 to 50 and t=3 to 25;
R₅ is H, C₁-C₂₀ alkyl, C₂-C₃₆ alkenyl, C₅-C₈ cycloalkyl, C₇-C₃₆ aralkyl or —(OCH₂CH₂)ₛ—(CH₂CHO)ₜ—(CH₂CH₂O)ₛH
m is 0, 1 or 2;
n is 0, 1 or 2 provided that (m+n)=1 or 2, where p=0; and where p is not 0, (m+n)=0, 1 or 2;
p is 0, 1, 2 or 3;
r is an integer from 0 to 50.

57. A CMU according to claim 48, further comprising any one or more of a dispersant, a plasticizer, a lubricant, a salt scavenger, or a viscosity modifier.

58. A CMU according to claim 48, having a value of 10% or less dampness and 5 pinholes or less as determined by the Standard Spray Bar Test and 60% or less water uptake as determined by the Standard Water Uptake test.

59. A CMU according to claim 54, having a value of 10% or less dampness and 5 pinholes or less as determined by the Standard Spray Bar Test and 60% or less water uptake as determined by the Standard Water Uptake test.

60. A concrete or cement composition, comprising: (a) a hydrocarbon-based water repellent and (b) a silane-siloxane composition.

61. A concrete or cement composition, according to claim 60, comprising:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

62. A cured concrete or cement composition, comprising: (a) a hydrocarbon-based water repellent (HCWR) and (b) a silane-siloxane (SS) composition.

63. A cured concrete or cement composition, according to claim 62, comprising:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.

64. A cured cement or concrete composition according to claim 62, having a value of 10% or less dampness and 5 pinholes or less as determined by the Standard Spray Bar Test and 60% or less water uptake as determined by the Standard Water Uptake test.

65. A method of making an admixture for concrete mixes, comprising, combining (a) a hydrocarbon-based water repellent (HCWR) and (b) a silane-siloxane (SS) composition.

66. A method for making a concrete masonry unit (CMU) comprising providing a concrete or cement composition comprised of:
4-25% (s/s total dry weight) hydratable cement binder;
74-95% (s/s total dry weight) relatively fine aggregate which is an aggregate blend or particle batch containing aggregates as fine or finer than Size Number 8 coarse aggregates as defined in ASTM C 33-07;
0.08 to 1.23% (s/s hydratable cement binder) HCWR, and
0.02 to 0.30% (s/s hydratable cement binder) SS.
